(19) United States
(12) Patent Application Publication
(10) Pub. No.: US 2006/0034158 A1
(43) Pub. Date: Feb. 16, 2006

(54) Method for position notification

(76) Inventors: Magnus Maurex, Stockholm (SE); Ulf Gullstedt, Sundbyberg (SE); Sergey Shudra, Kiev (UA)

Correspondence Address: YOUNG & THOMPSON, 745 SOUTH 23RD STREET, 2ND FLOOR, ARLINGTON, VA, 22202, US

(21) Appl. No.: 10/527,792

(22) PCT Filed: Sep. 8, 2003
(86) PCT No.: PCT/SE03/01398

§ 371 Date: Mar. 15, 2005

Related U.S. Application Data
(60) Provisional application No. 60/319,551, filed on Sep. 15, 2002.

(51) Int. Cl. G04C 11/00; G04C 13/00

(52) U.S. Cl. 368/46

(57) ABSTRACT

The method and system is for determining a position and time with a dynamic code (22). The method provides a time device (12) that shows a time (19) and a date (17). The time device (12) has a unique identification number (24). The dynamic real time code (22) is generated by combining the time (19) and the date (17) shown by the time device (12) and the identification number (24). The code (22) is packed and sent to a receiver (30). The receiver unpacks the code and determines the sending time (19) and date (17) and the identification of the time unit (12).

### BACKGROUND OF INVENTION

It is quite common for service providers, such as cleaning service or any other suitable service, to carry out a job or task without the person requesting the service being able to be at the location to check and make sure the service providers did not leave too early. The difference between the starting time and the completion time of a service is sometimes a good indicator that the service was properly carried out. However, there is currently no system available to reliably control service providers that carry out services in a remote location without actually going to the location to see the person or to review reports prepared by the service provider. Most currently available systems use static codes that do not change with time so that it is difficult to control when the service provider actually obtained the code reported to the person requesting the service. There is a need for a reliable and effective system that requires the service provider to be at the particular location when the reporting code is obtained.

### SUMMARY OF INVENTION

The method and system of the present invention provide a solution to the above-outlined problems. More particularly, the present invention is for determining a position and time with a dynamic code that changes with time and location. The method provides a time device that shows a time and a date. The time device has a unique identification number. The dynamic real time code is generated by combining the time and the date shown by the time device and the identification number. This code is packed and sent to a receiver. The receiver unpacks the code and determines the sending time and the identification of the time unit.

### BRIEF DESCRIPTION OF DRAWING

FIG. 1 is a schematic view of the components of the system of the present invention; and

FIG. 2 is a schematic view of the components of an alternative embodiment of the present invention.

### DETAILED DESCRIPTION

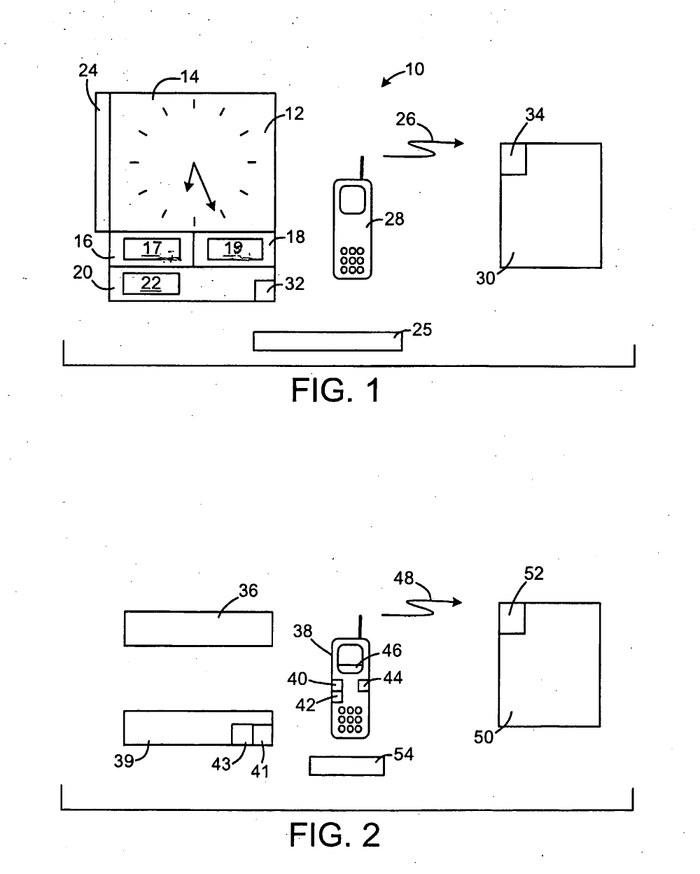

With reference to FIG. 1, the system 10 has a clock unit 12 that shows the current real time in a display 14 including a date unit 16 and a time unit 18. The unit 12 also has a code display 20 that shows a code 22 that is based on the real date and time shown in the units 16, 18, respectively, and a unique identification number 24 of the clock unit 12. The number 24 may be the manufacturing number or any other number that is unique to the clock unit 12. The system 10 may be used to identify the position and time of a user 26 to, for example, prove that the individual was at the location of the unit 12 at the time 17 and date 19 displayed by the units 16, 18.

The user 26 may view the code 22, shown in the code display 20, and send a message 26 that includes the code 22, such as an SMS message via a mobile telephone 28, to a receiving unit 30 such as a computer, that is hooked up to the telephone system to receive the message 26. It should be understood that the mobile telephone 28 is used as an illustrative example and any suitable communicator device such as PDA or other portable and non-portable computers could be used and that the invention is not limited to mobile telephones. The message 26 includes the code 22 and an identification of the mobile telephone 28. Preferably, the unit 12 includes a code generation unit 32 that processes the information from the units 16, 18 and the number 24 prior to displaying the code 22. The device 32 may use a suitable algorithm to generate the code 22. Because the code 22 is both based on the real time and the unique static number 24, the code 22 is dynamic and changes with time so that the code 22 is different at each instance. This also means that the user 26 must be at the unit 12 to obtain the code 22 in order to show or prove that the user 26, or somebody else, was at the location of the particular unit 12 at the particular time shown in the units 16, 18. It may also be possible to determine the position of the mobile telephone 28, at the time of the sending of the message 26 since the approximate location of mobile telephones are known to the telephone operators of the mobile telephone network.

The receiving unit 30 receives the encoded signal 26 and decodes the message in a decoding unit 34. The unit 34 decodes the message 26 to a decoded message 36. The message 36 includes information about the generation time of the code 22 and the identification number 24 of the clock unit 12. The message 36 also includes information about the user 26 since the telephone number of the telephone 28 may be included in the message 26. In this way, the unit 30 knows when, for example, a painting job was completed, and the location and sender of the message 26. It is also possible for the user 25 to enter the code 22 on a website or hand-deliver the code 22.

As shown in FIG. 2, it may also be possible to place or display codes 36, such as bar codes, at different locations, such as public bathrooms. The codes 36 are unique so that each location has a different code. In this way, the user 54 may enter the static identification number 36 of the particular location into the mobile telephone 38. The telephone 38 has an internal clock that shows the date 40 and the time 42. The telephone 38 has an encoding unit 44, which could be software or hardware based, that generates the dynamic code 46 based on the date 40, the time 42 and the number 36. The dynamic code 46 may be included in the message 48 that is sent to a receiving unit 50 that has a decoding unit 52, as explained above. The receiving unit 50 may then decode the message 48 to determine the time, location and identification of the sender 54 that sent the message 48 since the telephone number to the telephone 38 is included in the message 48. When the user 54 moves to a second public bathroom that has a different identification number 36, the user may report in the same way when the second location is visited also. In the alternative, the number 36 is a bar code that may be read by a bar code reader device 39 that has an internal clock 41 that can be used to generate the code 43. The information in the device 39 may then be downloaded and encoded.

In an alternative embodiment of the system 10, the communication device 28 may be associated with a radio-frequency identification device that provides the position identification and the device 28 may do the coding. The position identification and the code may then be transferred by Bluetooth, or any other communication mode, such as sound. The device 28 may also be associated with a GPS device so that the position identification is provided by the GPS device and the code generation may be carried out in the GPS device also. The device 28 may also have activity feature, such as cleaning, medicine etc. that may be automatically activated by 20 activating the feature so that the extra information may be included in the signal 48 that is sent to the receiver 50. It is also possible to manually add the activity feature after the generation code.

While the present invention has been described in accordance with preferred compositions and embodiments, it is to be understood that certain substitutions and alterations may be made thereto without departing from the spirit and scope of the following claims.

1. A method of determining a position and time with a dynamic code, comprising:
providing a time device (12) showing a time (19) and a date (17), the time device having a unique identification number (24);
generating a dynamic real time code (22) by combining the time (19) and the date (17) shown by the time device and the identification number (24); and
sending the dynamic real time code (22) to a receiver (30).

2. The method according to claim 1 wherein the method further comprises generating the code in an encoding unit (32) prior to sending the code (22).

3. The method according to claim 1 wherein the method further comprises the receiver unpacking the code in a decoding unit (34) and determining the sending time (19) and the date (17) of the code (22) and the identification number (24) of the time device (12).

4. The method according to claim 1 wherein the method further comprises sending the dynamic real time code (22) as a telephone message (26) by using a mobile telephone (28).

5. The method according to claim 4 wherein the method further comprises the receiver (30) determining an identity of the mobile telephone (28) based on the telephone message (26).

6. The method according to claim 1 wherein the method further comprises the telephone (38) generating a dynamic code (46) based on a time (40), a date (42) and a number (36).

7. The method according to claim 6 wherein the method further comprises the telephone (38) sending the code (46) prior to sending a message (48) to a receiver (50).

8. The method according to claim 7 wherein the method further comprises the receiver (50) decoding the message (48) in a decoding unit (52).
